(19) United States
(12) Patent Application Publication
(10) Pub. No.: US 2010/0257108 A1
(43) Pub. Date: Oct. 7, 2010

(54) METHODS, SYSTEMS, AND COMPUTER READABLE MEDIA FOR BUILDING-SPECIFIC DATA MANAGEMENT USING A GLOBALLY UNIQUE IDENTIFIER

(76) Inventors: William H. Skeels, IV, Raleigh, NC (US); Roxanne M. Skeels, Raleigh, NC (US); Paul J. Michaels, Raleigh, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/726,086

(22) Filed: Mar. 17, 2010

Related U.S. Application Data
(60) Provisional application No. 61/160,903, filed on Mar. 17, 2009.

(51) Int. Cl. G06Q 50/00; G06Q 10/00; G01S 3/02; G01S 19/42; G06K 19/06; G06F 17/30

(52) U.S. Cl. 705/314; 342/450; 342/357.25; 235/494; 707/802; 707/705; 707/E17.107; 707/E17.044

(57) ABSTRACT

Methods, systems, and computer readable media for managing information associated with a building using a globally unique identifier are disclosed. According to one method, at a computing platform including at least one processor, a building identifier is assigned to a building, where the building identifier is a unique identifier within an identifier space assigned to building identifiers. Information associated with a transaction and the building is received, where the information is identified by the building identifier. The received information is automatically associated with the building using the building identifier.

### PRIORITY CLAIM

This application claims the benefit of U.S. Provisional Patent Application Ser. No. 61/160,903 filed Mar. 17, 2009; the disclosure of which is incorporated herein by reference in its entirety.

### TECHNICAL FIELD

The subject matter described herein relates to data management using identifiers. More specifically, the subject matter relates to methods, systems, and computer readable media for building-specific data management using a globally unique identifier.

### BACKGROUND

There currently exists a large amount and variety of building-specific data stored in various places, both online and offline. Moreover, this building-specific data is currently managed using a variety of different, largely manual systems. For example, utility bills, real estate transaction records, and home repair service records are typically organized by a homeowner using a physical data management system (e.g., a filing cabinet), an electronic data management system (e.g., a database or home computer), or a combination of both. However, this places a burden on the homeowner to both gather the building-specific information and to organize the information effectively over a period of time. Typically, this period of time will include the length of ownership of the building (e.g., years or decades).

These problems are exacerbated due to the large number of houses and other buildings in the world. For example, building-specific data that may be associated with every residential building in the United States of America (i.e., approximately 113 million in 2009), may include a mailing address, primary owner name, legal description, assessor's parcel number (APN), lot size, square footage, year built, number of bedrooms, number of bathrooms, zoning, transfer date, first loan amount, first loan type, lender, last transaction date, cost per square foot, assessed value, tax amount, land value, and tax status. Thus, there may be tens to thousands of pieces of building-specific information associated with every building.

In addition to the large number of buildings that exist, each building may be associated with numerous building-related transactions over the course of its lifetime. Building-related transactions may be distinguished from other types of transactions, such as personal transactions, because building-related transactions relate in some way to a particular building while, for example, personal transactions can take place regardless of the existence of a building. Building-related transactions may generally be divided into two categories. The first category of building-related transaction includes real-estate transactions such as a sale, 1031 exchange, second mortgage, reverse mortgage, lien, etc. The second category of building-related transaction may include non-real estate transactions that occur during an owner's ownership of a building. Building-specific, non-real estate transactions may include paying for utilities provided to the building, repairs to the building, or maintenance services of either the land or durable goods associated with the building. During the lifespan of a typical building, many real-estate and non-real estate transactions may occur. As a result, the tens or hundreds of pieces of building-specific information associated with each building may be multiplied by the number of ownership transfers of the building.

One conventional solution for managing building-related data includes organizing the building-related data information by postal address. However, one problem associated with postal addresses is that postal addresses do not always uniquely identify a particular building. An additional problem with postal addresses is that they are expressed in non-standard ways, e.g., 1433 Southeast Oak Street can be expressed as “1433 Southeast Oak St”, “1433 SE Oak Street” or in various other ways. Electronic databases are prone to errors, and mail delivery is fallible. As a result, information intended to be associated with the building is not always delivered or associated with to the building.

Accordingly, in light of these difficulties, a need exists for improved methods, systems, and computer readable media for managing building-specific data.

### SUMMARY

Methods, systems, and computer readable media for managing information associated with a building using a globally unique identifier are disclosed. According to one method, at a computing platform including at least one processor, a building identifier is assigned to a building, where the building identifier is a unique identifier within an identifier space assigned to building identifiers. Information associated with a transaction and the building is received, where the information is identified by the building identifier. The received information is automatically associated with the building using the building identifier.

A system for managing information associated with a building using a globally unique identifier is also disclosed. The system includes a communications module for receiving information associated with a transaction and the building, where the information is identified by a building identifier that is a unique identifier within an identifier space assigned to building identifiers. A database module assigns the building identifier to a building and automatically associates the received information with the building using the building identifier.

The subject matter described herein for managing information associated with a building using a globally unique identifier may be implemented using a non-transitory computer readable medium having stored thereon executable instructions that when executed by the processor of a computer control the computer to perform steps. Exemplary non-transitory computer readable media suitable for implementing the subject matter described herein include chip memory devices, disk memory devices, programmable logic devices, and application specific integrated circuits. In one implementation, the computer readable medium may include a memory accessible by a processor. The memory may include instructions executable by the processor for implementing any of the methods for managing information associated with a building using a globally unique identifier described herein. In addition, a computer readable medium that implements the subject matter described herein may be distributed across multiple physical devices and/or computing platforms.

As used herein, the term “building” refers to any discrete constructed building that may include any and all of single-family detached homes, multiple occupancy dwellings, mobile homes, commercial buildings, and operational buildings such as power stations.

### BRIEF DESCRIPTION OF THE DRAWINGS

The subject matter described herein will now be explained with reference to the accompanying drawings of which:

FIG. 1 is a diagram of an exemplary BuildingCode suitable for managing data associated with a building according to an embodiment of the subject matter described herein;

FIG. 2 is block diagram of exemplary components for managing data associated with a building using a BuildingCode according to an embodiment of the subject matter described herein;

FIG. 3 is a flow chart of exemplary steps for managing data associated with a building using a BuildingCode according to an embodiment of the subject matter described herein;

FIG. 4 is a screenshot of an exemplary software interface for managing data associated with a building using a BuildingCode according to an embodiment of the subject matter described herein;

FIGS. 5A and 5B are a flow chart of an exemplary timeline and corresponding real-world application of managing data associated with a building using a BuildingCode according to an embodiment of the subject matter described herein;

FIG. 6A is a perspective line drawing of an interior of a garage;

FIG. 6B is a perspective line drawing of exemplary structural and functional components located behind an interior wall of a garage suitable for gathering and managing data associated with the components using a BuildingCode according to an embodiment of the subject matter described herein;

FIG. 7A is a perspective line drawing of a yard associated with a house; and

FIG. 7B is a perspective line drawing of exemplary functional components located beneath a yard associated with a house suitable for gathering and managing data associated with the components using a BuildingCode according to an embodiment of the subject matter described herein.

### DETAILED DESCRIPTION

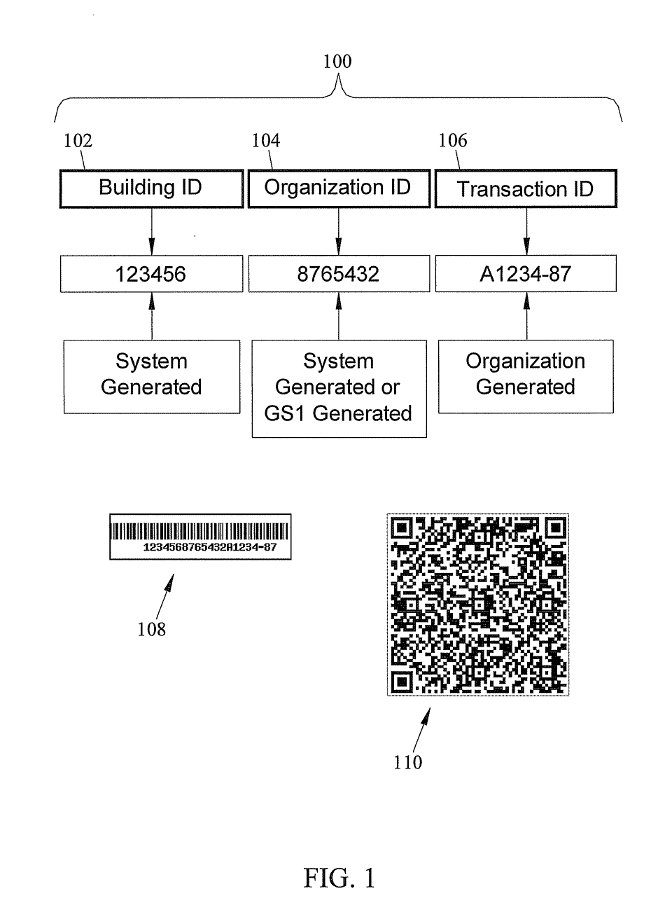

The subject matter described herein includes methods and systems for managing building-specific information using a globally unique identifier to link building-specific data with a particular building using a globally unique identifier (e.g., a building ID) that is uniquely assigned to that building. In one embodiment, the system may include a web portal accessible by the owner of the building using a username and password where all a building-specific information is aggregated and displayed in a unified way. Moreover, building-specific data stored in various other electronic databases may automatically be obtained, stored, and/or linked to using the globally unique identifier assigned to the building. By associating building-specific data with a globally unique building-specific identifier, management of building-specific data may be simplified. While it is appreciated that the globally unique building-specific identifier (e.g., building ID) forms the foundation of the subject matter described herein, other optional identifiers may also be used for further simplifying management of building-specific information. Thus, the building ID and any optional identifiers may be included in a suitable container format that may be appended to building-specific information. An exemplary container format suitable for storing a building ID and other optional identifiers (e.g., a BuildingCode) will now be described below with respect to FIG. 1.

### BuildingCode

FIG. 1 is a diagram of an exemplary format including a globally unique building identifier and other optional identifiers being assigned to a building and used for managing building-specific data according to an embodiment of the subject matter described herein. Referring to FIG. 1, BuildingCode 100 may be a container format that specifies how various building-specific identifiers are stored. As used herein, a container format is a meta-file format whose specification describes how data and meta-data are stored (not coded). Therefore, while a computer program may be able to identify and open a container file, the computer program may not be able to decode the contained data. It is appreciated that, according to the subject matter described herein, the globally unique building identifier that may be assigned to a building and used for managing building-specific may be hereinafter referred to as a building ID rather than BuildingCode 100. However, for the sake of illustration, several optional identifiers are used in addition to the building ID. Therefore, the term BuildingCode may be used throughout the subject matter described herein but is not intended to be limiting to embodiments that include optional, non-building ID components. Thus, in one embodiment, BuildingCode 100 may include only a building ID, while in other embodiments BuildingCode 100 may include a building ID and other various identifiers.

In the embodiment shown in FIG. 1, BuildingCode 100 may include a building ID 102, an organization ID 104, and a transaction ID 106. Therefore BuildingCode 100 may be able to cross-reference and attach transactions to any or all BuildingCode-compliant data relating to a building, organization, or transaction identified by BuildingCode 100.

### Building ID

Building ID 102 is a globally unique identifier associated with a specific physical building. It is appreciated that building ID 102 may include any alphanumeric or non-alphanumeric character sequence suitable for uniquely identifying a building. As such, building ID 102 is a unique identifier within an identifier space assigned to building identifiers. For example, building ID 102 may include the alphanumeric sequence “123456” for uniquely identifying a particular building from among all other buildings in the world (i.e., no other building is assigned the building ID 123456).

Building ID 102 may serve as the linking mechanism for historical and/or prospectively generated information relating to a house or other building. Building ID 102 may provide a mechanism for enabling a building ID-compliant database to exchange information associated with a building with various other databases or electronic entities. Processes referencing building ID 102 may, in turn, be able to be linked together for any useful purpose.

Building ID 102 may be assigned and dispensed by a central authority (e.g., a company, or its designee) and be maintained, for example, by a central building ID database. Additionally, it is appreciated that building ID 102 may be expressed in a variety of formats depending on its application. For example, building ID 102 may be expressed as a number that is visually read and manually transcribed by a person similar to a credit card number or, alternatively, building ID 102 may be electronically read using a barcode or RFID reader when building ID 102 is expressed as a barcode or an RFID tag. Examples of two popular barcode formats used for expressing building ID 102 will now be described in greater detail below.

In one embodiment, building ID 102 may utilize an internationally recognized barcode standard, such as a universal product code (UPC), to express the number 123456 as a series of vertical lines. For example, barcode 108 may be a one-dimensional (1D) barcode (i.e., while barcode 108 may be displayed in two-dimensions, data is only encoded in one dimension) having multiple vertical bars of varying widths separated by spaces of varying widths.

In another embodiment, building ID 102 may utilize a two dimensional (2D) barcode standard for encoding a greater density of information. 2D barcode 110 may encode information in two dimensions rather than one dimension as is the case with conventional barcode 108. For example, 2D barcode 110 may encode all of building ID 102 (i.e., 123456), organization ID 104, and transaction ID 106 in approximately the same size area as barcode 108. In the exemplary format shown, 2D barcode 110 may include a square shape having one or more reference or anchor points located in one or more corners of the square. Reference points may help a visual scanner to determine the boundaries and/or correct orientation of 2D barcode 110.

It is appreciated that the identifier space of building ID 102 may include, or be consistent with, a standard protocol other than the barcode standard and that building ID 102 is not limited to any existing protocol or format. As used herein, an identifier space refers to the range of all acceptable values or acceptable combinations of values, whether alphanumeric or non-alphanumeric, for uniquely identifying a building. Exemplary formats for expressing building ID 102 may include 3-DI, ArrayTag, Aztec Code, Small Aztec Code, Chromatic Alphabet, Chromocode, Code 1, Code 16K, Code 49, ColorCode, Compact Matrix Code, CP Code, CyberCode, d-touch, DataGlyphs, Datamatrix, Datastrip Code, Dot Code, EZcode, Grid Matrix Code, High Capacity Color Barcode, HueCode, INTACTA.CODE, InterCode, MaxiCode, mCode, MiniCode, Micro PDF417, MMCC, PaperDisk, PDF417, PDMark, QR Code, QuickMark Code, Semacode, SmartCode, Snowflake Code, ShotCode, SuperCode, Trillcode, UltraCode, UnisCode, VeriCode, VSCode, and WaterCode.

Building ID 102 may be associated with existing (e.g., historical) building-specific data in order to organize previously generated building-specific information retrospectively. The process of associating building ID 102 with existing, historical building-specific data and may be referred to as “adopting” a building. When a building is first entered into the system according to the subject matter described herein, the central authority may assign a building ID 102 to the building and gather any historical information associated with the building. The information may then be linked together in a database using the building ID 102. Historical building-specific data may include (but is not limited to) any building component, physical material, appliance, documents, utility data, or other goods or services, and that serves to automatically link those items to the house and all other items related to the house. For example, building-related information may include utility bills, construction materials, installed appliances, repair records, tax receipts, or existing house-related documents. The building ID can be used at any relevant point, using any applicable software or device, throughout the sales and closing process. Later transfer of the information (into a BuildingCode-compliant database or elsewhere) may automatically link up with all other building-centric data. BuildingCode-compliant systems may support continued maintenance of historical data and acquisition of new data into the history on an ongoing basis.

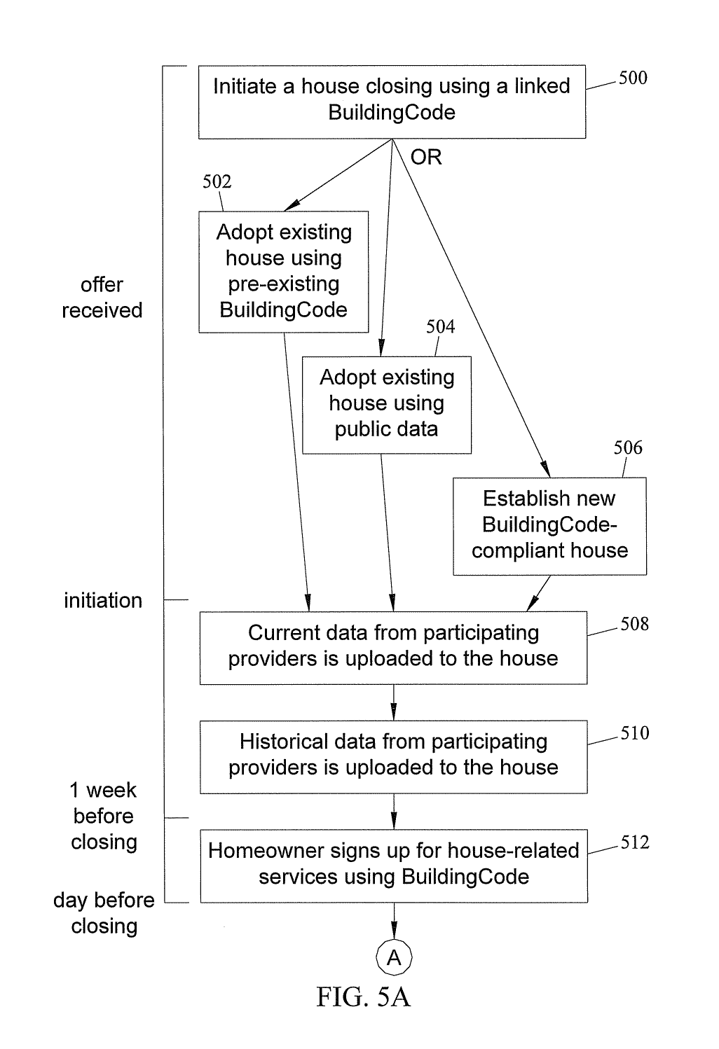

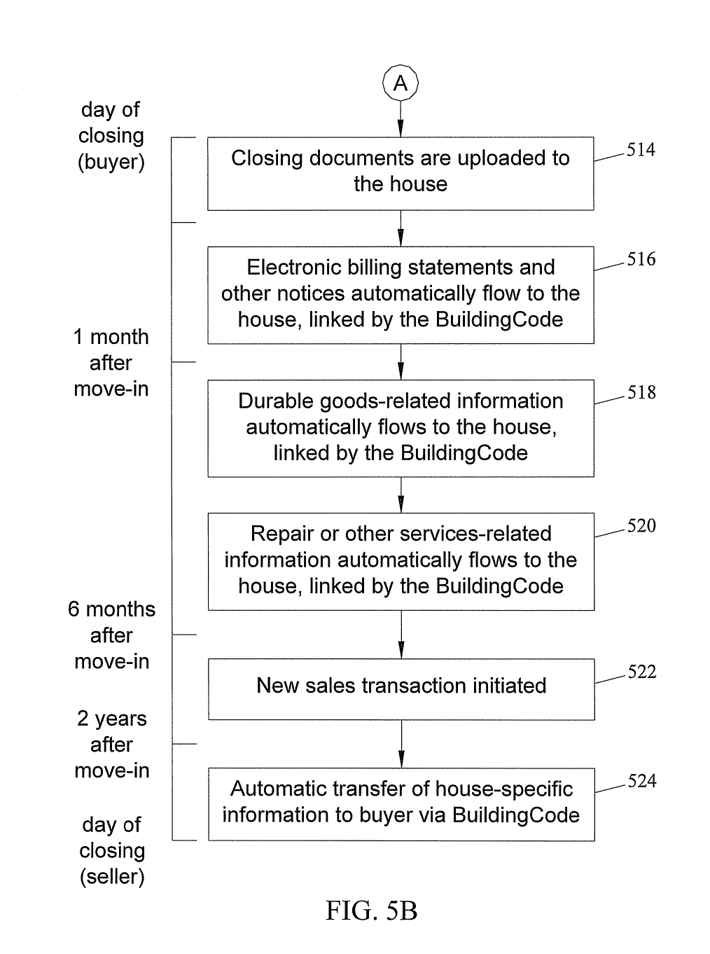

Building ID 102 may also be associated with building-specific information prospectively. For example, after a building has been adopted into the HouseCache system, building-specific information that is newly created within or gathered by an application may automatically be associated with building ID 102, gathered by the system, and organized for presentation to a user. Newly generated information that may be linked by building ID 102 may include home closing documents, system-generated warranty registrations, utility and other service signups, new repair or materials orders, targeted advertising, information and services, coupons or catalogs. For example, an owner of a home having a previously assigned building ID 102 may purchase a refrigerator at a local appliance store. The appliance store may have an electronic database containing invoice and warranty information for the appliances it sells. Further, the appliance store may support the use of BuildingCode-compliant building IDs 102. Therefore, the HouseCache system may automatically communicate with the appliance store's database in order to receive the invoice and warranty information for the refrigerator that is now specifically associated with the building. This may be accomplished, for example, by querying the appliance store's database using the building ID 102 as the search key. Alternatively, the appliance store may automatically transmit the information appended to the building ID 102 to the HouseCache system. In either case, the HouseCache system may either store the information provided by the appliance store (e.g., in a HouseCache database) or may link to the information stored remotely so that when the user requests the information via the HouseCache system, the information may be seamlessly retrieved from the remote location and presented to the homeowner within the HouseCache system. An exemplary usage scenario will be described in greater detail below with respect to FIG. 5.

### Organization ID

Organization ID 104 may include an identifier that identifies an organization associated with building-specific information. Any organization wishing to associate itself as the source of documents, utility data, household targeted advertisements, building components, physical materials or other goods, services, or activities with a building may do so by appending its organization ID 104 to building ID 102 being contained within a BuildingCode 100.

In one embodiment, an organization may utilize its UPC vendor code for its organization ID 104. It is appreciated that the left six digits of a UPC code identify a vendor and is assigned by a UPC authority. For example, the UPC authority may assign the vendor code 8765432 to a particular organization (e.g., vendor, manufacturer, distributor, servicer, etc.). Therefore, instead of generating a new organization ID 104 that is valid only for use with a system according to the subject matter described herein (i.e., a HouseCache-compliant system), the vendor may simply co-opt their already-assigned UPC vendor code as their organization ID.

In another embodiment, the organization may register and obtain a non-UPC-based organization ID 104 (e.g., an organization ID issued by a system according to the subject matter described herein). Regardless of whether a UPC-based vendor code or non-UPC-based vendor code is used for organization ID 104, organization ID 104 may be used to associate an organization with an individual building as identified by its building ID 102. For example, by including both an organization ID 104 and a building ID 102 within a BuildingCode 100, an organization may associate a power company statement to a specific building's utility bill or associate a specific appliance to the house where it was installed. Thus, a BuildingCode 100 that contains both building ID 102 and organization ID 104 relates to, and cross-references with, documents, utility data, household targeted advertisements, building components, physical materials or other goods or services or activities which that organization supplies or controls.

### Transaction ID

BuildingCode 100 may also include transaction ID 106 that uniquely identifies a transaction. Exemplary types of transaction ID 106 may include, but are not limited to, invoice numbers and packing or shipping labels.

BuildingCode 100 may include both the building ID 102 itself, as well as a unique number assigned to the particular closing transaction (e.g., transaction ID 106).

### HouseCache™ System

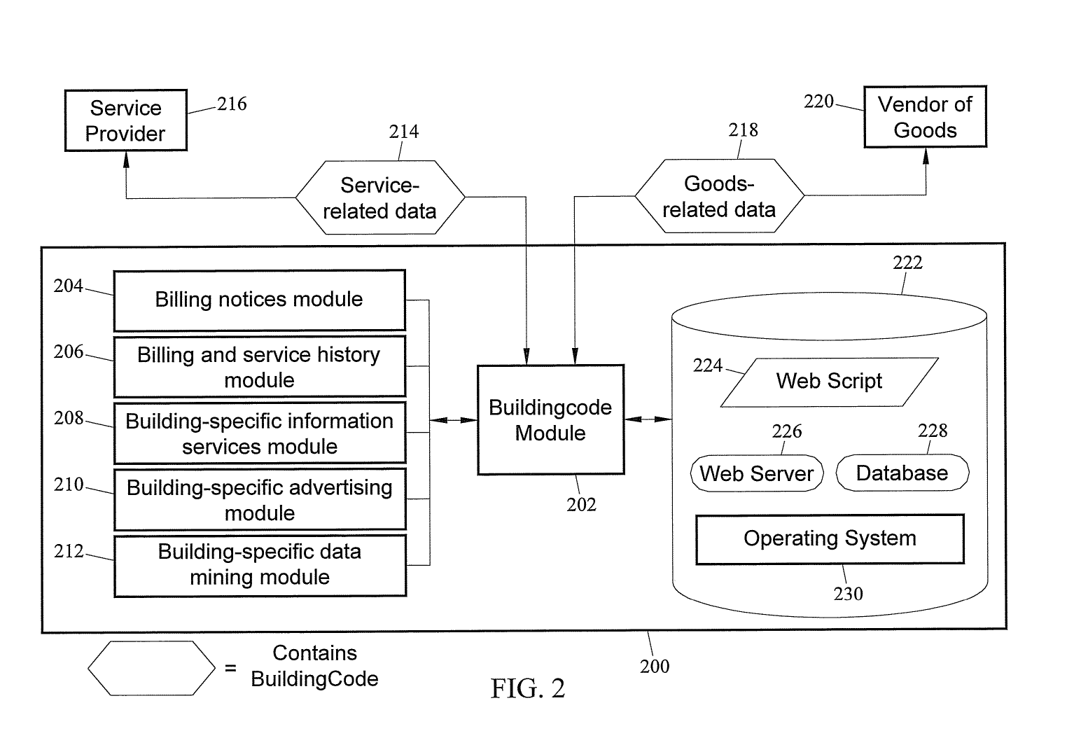

FIG. 2 is block diagram of exemplary components in a system for managing building-specific data using a globally unique identifier according to an embodiment of the subject matter described herein. Referring to FIG. 2, HouseCache system 200 may be implemented using computer readable instructions embodied on a tangible, non-transitory computer readable medium that when executed by one or more processors of a computer make the computer perform various steps. HouseCache system 200 may be implemented on a single computer or may be distributed across multiple physical devices and/or computing platforms. For example, HouseCache system 200 may include a server having multiple data processing blades and a data storage device. Various modules executed by the server may perform functions such as sending and receiving service- or goods-related data containing building ID 102 to remote service providers or goods vendors, storing the service- or goods-related data associated with each building ID 102, and presenting the service- or goods-related data to owners of buildings based on their unique building ID 102.

BuildingCode module 202 may assign a globally unique identifier (e.g., a building ID) to a building. BuildingCode module 202 may also receive information associated with a transaction and the building and identified by the building identifier. For example, BuildingCode module 202 may be communicatively coupled with billing notices module 204, billing and service history module 206, building-specific information services module 208, house-targeted advertising module 210, and house-specific data mining module 412.

Billing notices module 204 may store and present notices of currently pending bills to the user. For example, billing notices module 204 may include separates categories for an electric bill, telephone bill, mortgage bill, tax bill, or any other outstanding (i.e., unpaid) bill. It is appreciated that billing notices module 204 may store billing notices having different recurrent time periods, grace periods, and/or penalties. For example, an electric bill may be due monthly on the first day of each month and have a flat $15 penalty fee if not paid within 10 days, while a property tax bill may be due annually and have a percentage penalty if not paid within 60 days.

Billing and service history module 206 may include historical information associated with bills and/or services that have been performed or paid for. For example, billing and service history module 206 may store every electric bill received so that an owner can track his or her usage over time. Likewise, the date and cost of services performed on the building may be stored by billing and service history module 206 so that an owner may have an accurate picture of the health of the building. This may be especially important for services that occur several years apart because it may be difficult for an owner to remember the services that have been provided over the lifetime of the building.

Building-specific information services module 208 may organize, manage, and/or display information to users other than owners of buildings. In other words, building-specific information services module 208 may be responsible for managing the interface between administrators of system 200 rather than end users. For example, Building-specific information services module 208 may allow an administrator to create a new building ID 102 or organization ID 104, remove or edit information, or generate reports.

House-targeted advertising module 210 may store or provide advertisements relevant to one or more characteristics of the building. For example, if the service history or materials list associated with a building indicates that the building includes wall-to-wall carpeting that is twenty years old, then house-targeted advertising module 210 may present carpeting advertisements for sales on carpeting. Similarly, house-targeted advertising may include advertisements for energy efficient heat pumps if the electric bill history in billing and service history module 206 indicates an above average energy consumption for the building.

House-specific data mining module 212 may extract patterns from building-related data. For example, House-specific data mining may include classification, clustering, regression, and association rule learning. Classification includes arranging data into predefined groups. For example house-specific data mining module 212 may classify a service provided for the building as either increasing a building's value (e.g., add a swimming pool or deck) or maintaining the building's value (e.g., cleaning, minor roof repair). Clustering includes grouping similar items together, but unlike classification, the groups are not predefined. For example, monthly bills may be grouped together and annual bills may be grouped together. Regression includes modeling data with the least error by estimating the average value of a dependent variable while one or more independent variables are held fixed. For example, using regression analysis, house-specific data mining module 212 may predict a building's future heating bill based on other variables such as the size of the house, the geographic location, and the number of windows. Association rule learning may include searching for relationships between variables. For example, using association rule learning, house-specific data mining module 212 may determine which services are frequently bought together and use this information for marketing purposes.

BuildingCode module 202 may also associate the received information with the building using the building identifier. For example, BuildingCode module 202 may be associated with web platform 222. Web platform 222 may include any combination of hardware, software, and/or firmware for executing the functions associated with BuildingCode module 202. Web platform 222 may include a processor and memory for executing software code and various communications interfaces for sending and receiving information with other devices.

In the embodiment shown in FIG. 2, web platform 222 may include web script 224, web server 226, database 228, and operating system 230. Web script 224 may include any suitable scripting language for receiving or presenting information to a user that is associated with a building and linked by a globally unique building ID. For example, web script 224 may include hypertext preprocessor (PHP), Perl, or Ruby. Web server 226 may include any suitable entity for serving hypertext transfer protocol (HTTP) information to a user. For example, web server 226 may include an Apache or Internet information services (IIS) web server. Database 228 may include any suitable data building for storing information that is associated with a building and linked by a globally unique building ID. Database 228 may include a my-structured query language (mySQL), SQL server, Oracle, or PostgresSQL database. Operating system 230 may include any suitable interface between hardware and a user that is responsible for management and coordination of activities and sharing of hardware resources and acts as a host for computing applications run on the machine. Operating system 230 may include Windows, Linux, or Unix operating systems.

Returning to BuildingCode module 202, BuildingCode module 202 may be configured to receive service-related data 214 from service provider 216. For example, the service history and contact information for the house's HVAC system may be automatically stored and presented by HouseCache system 200. For a new home buyer, historical information may be presented so that the new buyer can leverage the previous owner's experience with a particular HVAC repair service rather than reinventing the wheel. Further, any new services performed may automatically update the service history presented. For example, appliance information may automatically flow to the BuildingCode-compliant house-centric database and automatically link to appliance-relevant information (e.g., warranty, manuals, spare parts, etc.).

BuildingCode module 202 may also be configured to receive goods-related data 218 from goods vendor 220. For example, warranty information for appliances such as stoves and refrigerators may automatically be retrieved from vendor databases or websites using the building ID and stored in the house-centric database accessible anytime by the user. This may include an Adobe portable document format (PDF) image of the physical warranty information originally provided with the durable good at the time of purchase, a link to the vendor's website, a digital photo file, or a presentation of the information in a format determined by system 200.

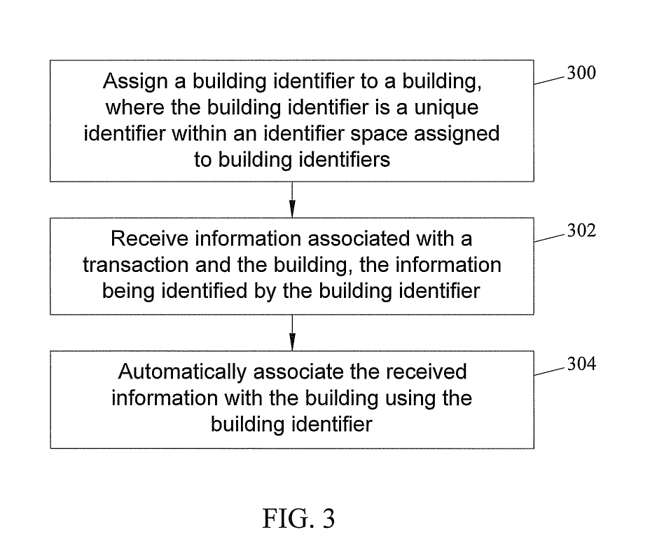

FIG. 3 is a flow chart illustrating exemplary steps for managing data associated with a building using a BuildingCode according to an embodiment of the subject matter described herein. Referring to FIG. 2, in step 300, a building ID is assigned to a building, where the building ID is globally unique. For example, building ID 102 may include the value 123456 and may be associated with a first building (e.g., located at 123 Main Street, Durham, N.C., USA). Building ID 102 may uniquely identify the building from all other buildings because no two building IDs may be the same while other identifiers for the building may not.

In step 302, information associated with a transaction and the building is received, where the information is identified by the building ID. For example, a utility bill may be electronically received by data management system 200 organized by building ID. In addition to the information normally included in the utility bill such as the bill amount, billing period, and customer name, the electric bill may be delivered to the data management system along with the unique building ID associated with the building being billed.

In another embodiment, photos or other image data may be associated with a building ID, including photos of the building associated with the building ID as it is being built. For example, during construction of a building, such as a conventional residential single family detached house, the contractor, owner, or another entity may take photos of various aspects of the house as it is being built and again after completion in order to provide easy access to structural and other hidden information at a later time. Types of information that may be useful in photographing include plumbing, electrical wiring, and the location of studs. By associating this information with a building ID, a huge amount of information that may be important to a builder, homeowner, or service provider may be easily obtained without the need for costly and/or time-consuming investigative processes. Conventional investigative processes typically include drilling holes in walls, removing drywall, x-ray scanning, digging up dirt, or removing flooring.

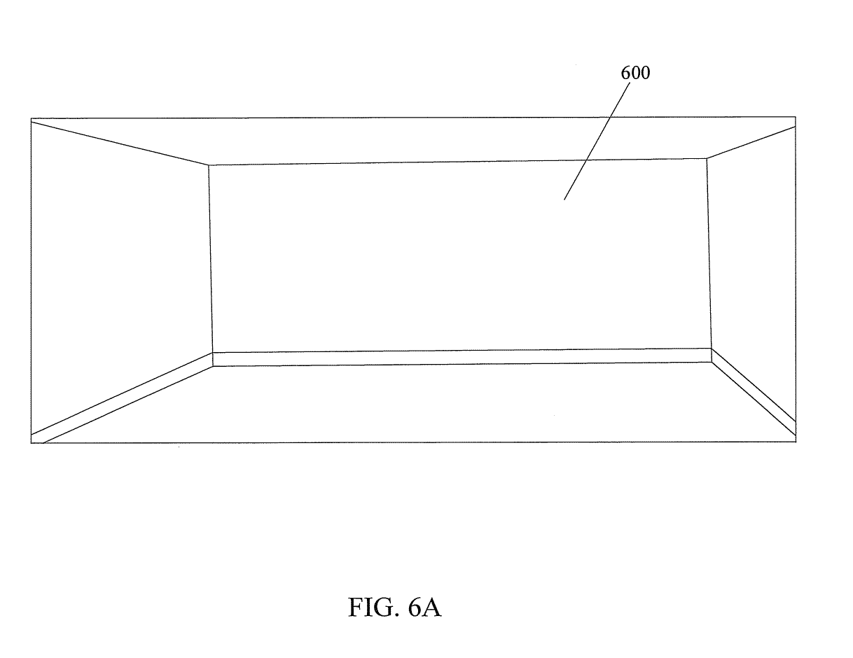

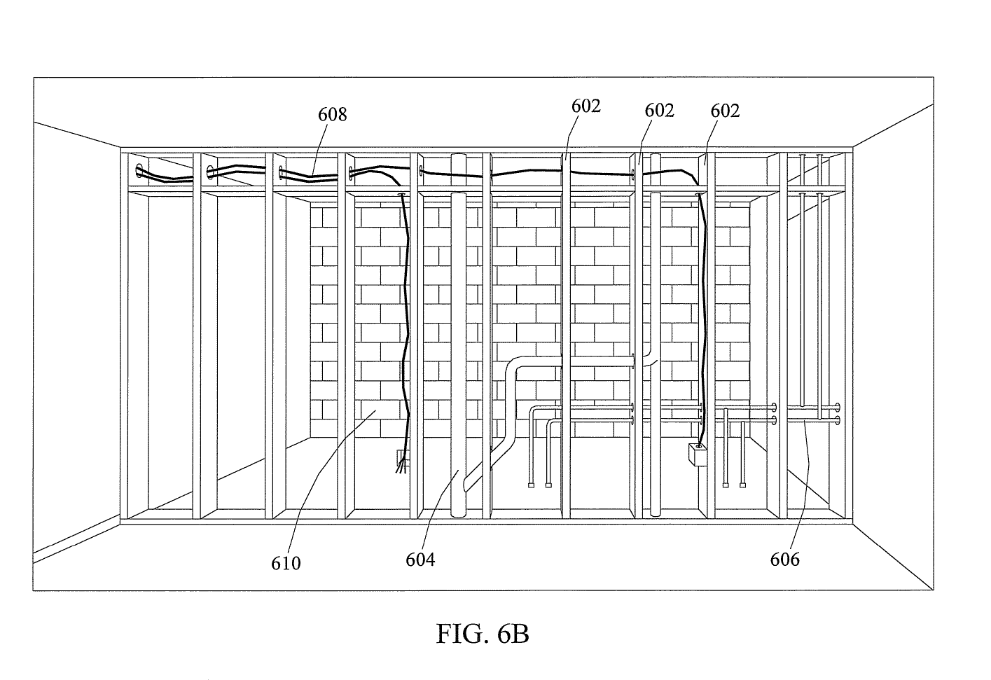

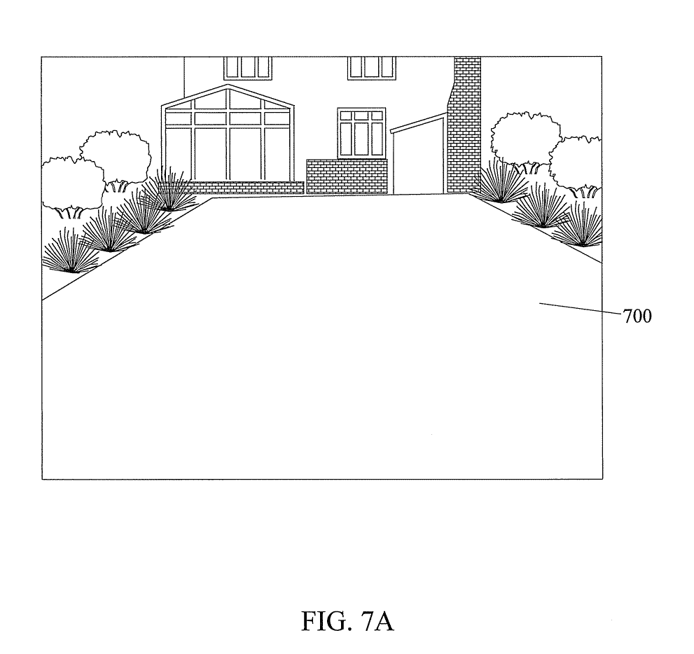

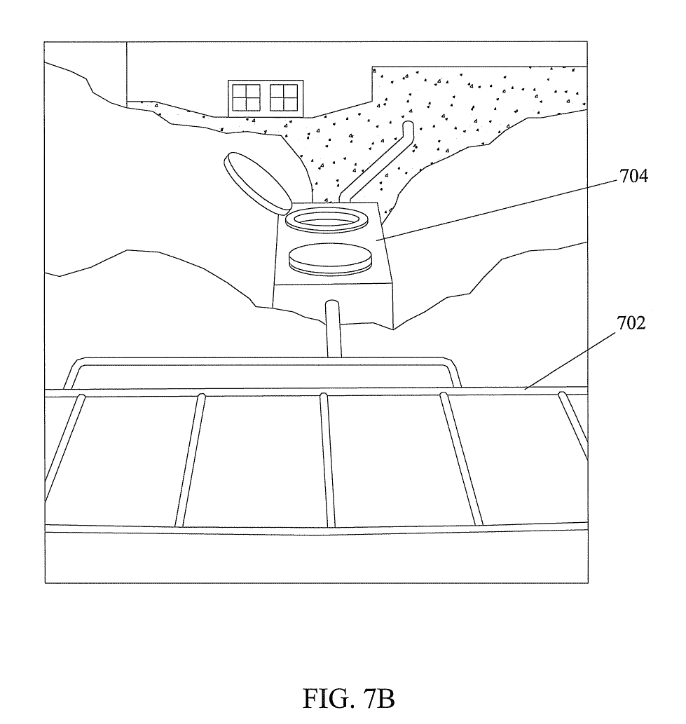

Associating image information with a building ID also allows for ongoing, real-time updates in the construction process, thereby reducing or eliminating the need for lender walkthroughs and progress updates. Preserving vital information about the building and linking it to a Building ID, provides means for easy, location-specific means for organizing and maintain visual information concerning the building. Further details of associating information with a building ID during construction will be described in greater detail below with respect to FIGS. 6A-6B and 7A-7B.

In step 304, the received information is associated with the building using the building identifier. For example, an electric bill for billing period January, 2009 along with building ID 123456 may be received by a BuildingCode compliant system in step 302. The BuildingCode compliant system may perform a lookup in a database for building ID 123456 and insert the received information in a corresponding entry. Thus, the owner of the building identified by building ID 123456 may log into the BuildingCode compliant system, for example, via a web interface and view his or her electric bill. It is appreciated that this process may be repeated for all types of information associated with the building and, therefore, may all be easily viewed at a central location being linked together by the building ID. Moreover, it is appreciated that similar information may be received over time (e.g., electric bills for January, February, March, etc.) and tracked using the BuildingCode compliant system. For example, historical data may share the same building ID and organization ID, but each transaction would be associated with a different transaction ID.

From the time of registration and receipt of a BuildingCode compliant unique code from the BuildingCode repository, all house related data, whether relating to documents, utility data, household targeted advertisements, information and messaging, building components, physical materials or other goods or services references the Building ID, and thus may be associated for various useful purposes with its building and grounds, and other related goods, services and information, present and past.

Assignment of Building IDs to house-related data may be made prospectively or retrospectively, and such assignment of the building ID to any documents, utility data, household targeted advertisements, information and messaging, building components, physical materials or other goods or services or any tangible or intangible thing serves to bind such items for billing, analytical, reporting, scheduling or other purposes. The BuildingCode method provides a mechanism for enabling data processes to link information about a house or other building. Processes which reference the building ID will, in turn, be able to be linked for any useful purpose, including organization, cross-reference and collation of related information concerning registered buildings.

Access to the Building ID, through any electronic method or channel, provides a means of linking house-related data, providing, for instance, automatic access to all available house-centered information managed inside any BuildingCode-enabled system. Data such as the correct address, all the register of deeds information, tax records, neighborhood school districts, and other similar geographic and government maintained information, would flow into the BuildingCode-enabled system, notably (but not limited to) the ClearClosing workspace which will control the home closing. That association will, in turn, permit direct billing to the resident, analysis and reporting of physical plant information and goods, utilities and services history, and other functions which relate to the building and all documents, utility data, house-centric advertisements, information and messaging, building components, physical materials or other goods or services which relate to that building.

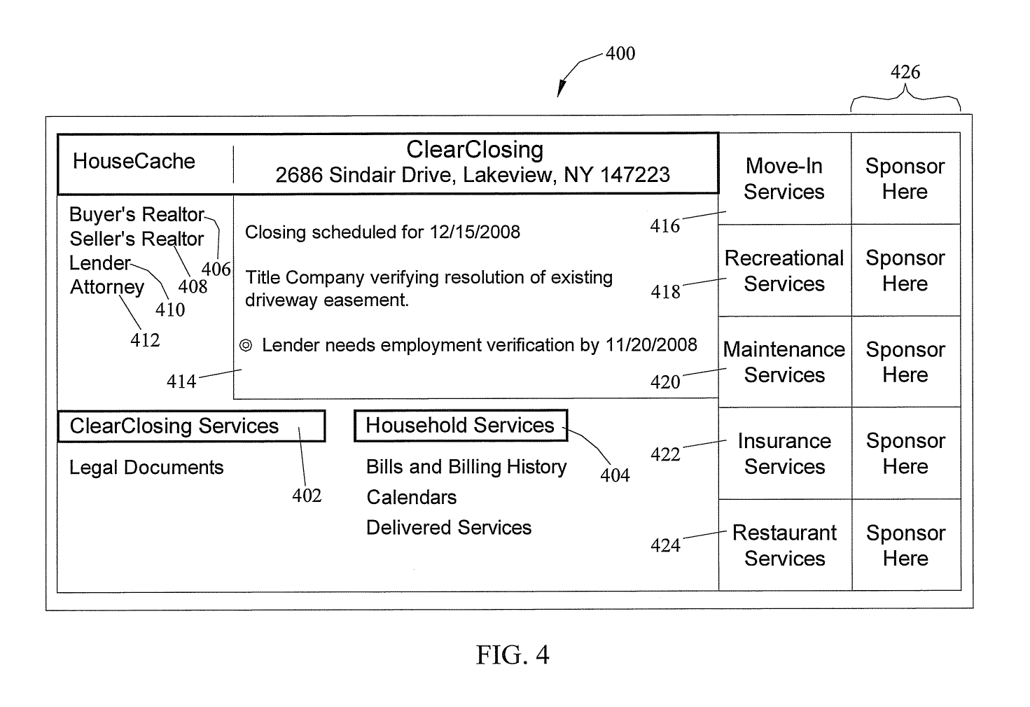

FIG. 4 is a line drawing of a computer screenshot illustrating an exemplary software interface for managing data associated with a building using a BuildingCode according to an embodiment of the subject matter described herein. Referring to FIG. 4, graphical user interface (GUI) may be displayed on a display associated with a computer. It is appreciated that GUI 400 may provide user interaction with a software application that is executed locally on a user's computer or may represent a webpage or webservice that allows the user to interact with a software application executed remotely on one or more server computers.

GUI 400 may be divided into several areas for defining user navigation and presentation of information. At the lower-center and lower-left of GUI 400, title heading 402 includes “ClearClosing Services” and title heading 404 includes Household Services.” ClearClosing Services 402 may include a listing of services associated with the sale of a building, and clickable links to documents or information associated with the listed services. For example, ClearClosing Services 402 may include a link to various legal documents prepared by authorities associated with the building sale transaction, such as an attorney, inspector, or realtor. Household Services 404 may include a listing of services associated with maintaining the condition of the house, rather than its sale, and clickable links to documents or information associated with the listed services. For example, Household Services 404 may include “Bills and Billing History,” “Calendars,” and “Delivered Services” for providing information regarding bills for services associated with the house (e.g., power bill, water bill, etc.), an indication of the date(s) and time(s) when various services may be required (e.g., annual HVAC inspection), and a listing of services performed for the building, respectively.

In the upper-left portion of GUI 400, a listing of one or more entities or authorities associated with a sale of the building is presented. In the embodiment shown in FIG. 5, buyer's realtor 406, seller's realtor 408, lender 410, and/or attorney 412 may allow the user to access information specific to that entity or authority. For example, attorney 412 may be allowed to upload and view legal documents related to the building such as title certificates or deeds, while lender 410 may be able to upload and view financial documents related to the building such as income verification statements and loan documents. It is appreciated that the contents displayed in the pane located in the upper-left portion of GUI 400 may change based on whether ClearClosing Services 402 or Household services 404 is selected. For example, in the event that Household services 404 is selected, the upper-left portion of GUI 400 may instead list entities such as “MerryMaid Cleaning Service,” “Duke Power Company,” or “GreenThumb Lawn Care.”

In the center pane of GUI 400, a main display window 414 may be used to present the most specific information selected by the user. In the example shown in FIG. 5, center pane 414 indicates that the current postal address of the selected building is 2686 Sinclair Drive, Lakeview, N.Y., 14223. Additionally, center pane 414 indicates that (1) the closing is scheduled for Dec. 15, 2008, (2) the title company is currently verifying the resolution of an existing driveway easement, and (3) the lender requires (buyer) employment verification before Nov. 20, 2008. Thus, the user may easily see the current status of all relevant information for a building in one location accessible by the unique building ID associated with that building.

The right hand side of GUI 400 may include advertisements or links to various services provided by vendors which may be relevant to the user based on the location of the building and its current context (e.g., the user is buying the building, the user is selling the building, or the user is neither buying nor selling the building). In the example shown, the user is buying the building and the services presented at the right hand column of GUI 400 include services likely to be useful to a new home purchaser. For example, “Move In Services” 416 may include change of address forms provided by the post office or a phone number for a local moving company, “Recreational Services” 418 may include the location of nearby parks or movie theaters. “Maintenance Services” 420 may include the phone numbers of plumbers or electricians, “Insurance Services” 422 may include information for local homeowners, flood, or car insurance, and “Restaurant Services” 424 may include information about local dining options.

### Real Estate Transaction Usage Scenario—Real World Timeline

FIGS. 5A and 5B are a flow chart of an exemplary timeline and corresponding real-world application for managing data associated with a building using a BuildingCode according to an embodiment of the subject matter described herein. The examples provided are representative and are not intended to be exclusive. Reference to a (residential) house is for illustration purposes only.

Referring to FIG. 5A, shortly after an offer on a house is received in step 500, a house closing transaction may be initiated using a linked BuildingCode in one of three ways. For example, a closing professional (e.g., lender, realtor, attorney) may, in step 502, adopt an existing house using a pre-existing BuildingCode. For example, the closing professional may adopt an existing house-centric database record (with unique Building ID) representing a building previously created for a home, closing. Or alternatively, in step 504, an existing house may be adopted using public data. For example, an existing house-centric database record (with unique Building ID) representing a building created from public data. Or alternatively, in step 506, a new BuildingCode-compliant house may be established. For example, a new BuildingCode-compliant house-centric database record (with unique Building ID) to represent a building may be established upon intake of initial identifying information. Step 506 may either establish a new unique building ID for a house and linked closing transaction (with Transaction ID), or establishes a new closing transaction and links it to an existing unique building ID for an existing house entry in the system.

In the next timeframe, from initiation until the date of closing (e.g., approximately one week before closing), in step 508, current data from participating providers may be uploaded to the house. For example, data concerning tasks, documents, bills for goods and services, shipment documents and other appurtenances of sale or repair by participating service providers that is uploaded to the house-centric database management application may be automatically marked with the building ID and Transaction ID. Additionally during this time period, in step 510, historical data from participating providers may be uploaded to the house. For example, data concerning tasks, documents, bills for goods and services, shipment documents and other appurtenances of sale or repair by participating service providers which are previously marked with the building ID and transaction ID and uploaded to the BuildingCode-compliant house-centric database will automatically link to the matching building and transaction.

In the next timeframe, until the date of closing (e.g., the week before closing), in step 512, the prospective homeowner may sign up for house-related services using the BuildingCode for the house. For example, the prospective homeowner or renter signs up for various services (electric, gas, sewer, water, lawn, pharmacy, schools), with the signups pre-filled with information associated with the building ID in the house-centric database. The signup automatically forwards the Building ID, which enables participating vendors to incorporate the established building ID in future billing statements. Use of the building ID from the initial signup in future electronic billing statement notices automatically links the statement notice to the household.

Referring now to FIG. 5B, in the next timeframe, the day of closing, in step 514, any relevant closing documents may be uploaded to the house. For example, all documents required for the closing are linked with the Building ID, loaded to the house-centric database, thus associated thereafter with both the building and the closing transaction.

In the next timeframe, after closing and approximately one month after move-in (or indefinitely), the house-centric database repository is available for all additional house-related documents, through association with the building ID and upload to house-centric database. For example, in step 516, electronic billing statements/notices, branded with Building ID, transaction ID and Organization ID, flow to the BuildingCode-compliant house-centric database and are associated with specific building and household for notice, link to payment purposes.

Additionally, in step 518, durable-goods-related information may automatically flow to the house being linked by the BuildingCode. For example, warranty information for appliances such as stoves and refrigerators may automatically be retrieved from vendor databases or websites using the building ID and stored in the house-centric database accessible anytime by the user. This may include an Adobe portable document format (PDF) image of the physical warranty information originally provided with the durable good(s) at the time of purchase, a link to the vendor's website, a photo file, or a new presentation of the information within an electronic format generated by the HouseCache system.

Similarly, in step 520, repair or other services-related information may automatically flow to the house being linked by the BuildingCode. For example, the service history and contact information for the house's HVAC system may be automatically stored and presented by the HouseCache system. For a new home buyer, historical information may be presented so that the new buyer can leverage the previous owner's experience with a particular HVAC repair service rather than reinventing the wheel. Further, any new services performed may automatically update the service history presented. For example, appliance information may automatically flow to the BuildingCode-compliant house-centric database and automatically link to appliance-relevant information (e.g., warranty, manuals, spare parts, etc.). Likewise, vendors may deliver information relating to goods or services relevant to the location and/or specifics of the building to the BuildingCode-compliant house-centric database and its associated house-specific web space.

In the next timeframe, approximately two years after move-in, in step 522, the original buyer may now become the seller and a new sales transaction may be initiated.

In the next timeframe, on the day of closing, in step 524, the house-specific information may be automatically transferred to the new buyer using the building-specific Building ID. For example, a transaction history associated with an existing residence may either be purged or may automatically flow to a new residence or temporary storage based on categories and accompanying business rules. For example, a first exemplary category of information includes private information. Private information may include any information associated primarily with the owner and secondarily with the building which the owner of the building may not wish to permanently associate with a particular building. In other words, private information may include information that an owner wishes to travel with him to whichever building(s) he owns and to prevent from being accessible by a future owner of a building formerly owned by the owner. Private information may automatically perish on transfer.

A second exemplary category of information includes public source information. Public source information may include information that may be obtained through one or more public sources such as county, state, or federal tax records, deeds, liens, lawsuits, etc. It should be noted that public source information should be distinguished from public information in that public source information, as presented by the HouseCache system is not openly available to the public. Instead, public source information may be included in a secure database entry indexed by a Building ID, where authentication by a user is required for access. Public information, on the other hand, includes information that is openly available to any member of the public. While overlap may exist between public information and public source information, it is appreciated that any public information included in the HouseCache system as public source information may be aggregated and displayed in a manner organized around the building ID and requiring user authentication, neither of which is the case when gathering public information directly from various public sources. In contrast to private information, public source information may be automatically transferred to new owner upon transfer of ownership of a building. Public source information may include information such as the assessed property value for tax purposes or the metes and bounds description of the property.

A third category of information includes transferrable information. Transferrable information is neither purely public nor purely private, and the transfer of transferrable information may be the choice (e.g., under the exclusive control) of the user. For example, transferrable information may be configured to automatically transfer to the new owner unless the user opts out or overrides the transfer. Alternatively, transferrable information may not be automatically transferred to the new owner unless the user opts in or explicitly allows the transfer.

FIG. 6A is a perspective view of the interior of a finished garage. Referring to FIG. 6A, the garage may include a concrete floor, a left wall, a right wall, a ceiling, and rear wall 600. Rear wall 600 may be a dry wall or other material for covering various structural or functional elements such as electrical wires, drainage pipes, water pipes, and wooden studs. It is appreciated that it may be desirable to have information regarding these various structural and functional elements available to owners so that, for example, it may be readily determined whether wall 600 may be removed or drilled into safely. Moreover, it may be desirable for this functional and structural information to be easily transferrable between owners. Because much of this information is easily obtainable during construction but it hidden and comparatively difficult to obtain after construction is complete, it may be desirable to gather and organize structural and functional information and associated it with a building ID 102 for later retrieval.

FIG. 6B is a perspective view of the interior of the garage shown in FIG. 6A during construction. As may be appreciated in FIG. 6B, various exemplary structural and functional elements are observable. For example, behind wall 600 may be one or more studs 602 for bearing the load of the roof of the garage, drainage pipes 604 for providing sewer access/services, water pipes 606 for providing hot/cold water, electrical wires 608 for providing power and/or data, and finally, exterior wall 610 made of, for example, cinderblocks. During construction, images of structural and functional elements 602-610 may be obtained during construction along with physical measurements or other data. This information may be associated with the building ID associated with the house. Thereafter, the home owner may easily determine the location, type, age, etc. of the various functional and structural elements behind wall 600 without physically tearing into wall 600 or using specialized tools (e.g., electronic stud finders. Moreover, because the data may be obtained during construction, it is more likely to be accurate than other sources such as schematics which may or may not reflect the elements actually built. In addition to gathering functional and structural information for interior elements, information such as digital photos may be gathered during construction of exterior elements as well.

According to one embodiment, vital information concerning installation such as mechanicals, electric wiring, and cabling may be obtained using a handheld mobile device such as a global positioning system (GPS)-enabled, camera-equipped mobile phone. As builders, homeowners, and service providers become increasingly dependent on handheld devices, it may be convenient for them to utilize these mobile devices in order to obtain location-specific digital photos of functional and structural components that may be located behind walls of a building. For example, a user may install an application on his or her mobile phone such that when a picture is taken while the application is active, the application may automatically tag the picture with time, location, or other relevant metadata in a format readily understandable by the HouseCache system.

According to one embodiment, the functional and/or structural information gathered during construction may be retrieved using one-click electronic recall. For example, the same application implemented on the user's mobile phone described above for obtaining the information may also be used for retrieving it. A “smart location finder” application may allow for handheld device recall of any relevant functional or structural information for a particular location (e.g., on a wall) uploaded to the HouseCache system simply by clicking on the application in the vicinity of the location (e.g., the wall). In another example, one or more transmitters or transponders may be installed behind walls during construction whose location is known. After construction, a handheld device may be used to ping these transmitters to determine the exact location of every digital photo registered by the HouseCache system to within a few centimeters using, for example, triangulation. As used herein, a transponder includes a receiver-transmitter that generates a reply signal upon proper electronic interrogation. In other embodiments, GPS may be used to determine the locations of various structural or functional elements. It is further appreciated that other suitable location determination systems may be used without departing from the scope of the subject matter described herein.

FIG. 7A is a perspective view of a yard associated with a home. Referring to FIG. 7A, yard 700 may include a flat area of grass. It is appreciated that the view shown in FIG. 7A is the view seen by observers post-construction and may hide various functional or structural elements under yard 700 such as septic tanks and drainage fields.

FIG. 7B is a perspective view of yard 700 illustrating various exemplary functional elements that may be installed during construction. Referring to FIG. 7B, drainage pipes 702 may be connected to septic tank 704. For example, wastewater may be piped septic tank 704 from the sewer pipes in the house. As new water enters the tank, it displaces the water that's already there. The displaced water flows out of septic tank 704 and into a drain field made of perforated pipes 702 buried in trenches filled with gravel. A typical drain field pipe 702 is approximately 4 inches in diameter and may be buried in a trench that is approximately 4 to 6 feet deep and 2 feet wide. Gravel may be used to fill the bottom 2 to 3 feet of the trench and dirt may be used to cover the gravel, thereby hiding the drainage field and septic tank and creating yard 700. Similar to the interior scenario described above with respect to FIGS. 6A-6B, it may be desirable to readily obtain details of the various functional elements that may be buried underneath yard 700, either for the current homeowner or for transferring to a new homeowner.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

1. A method for managing information associated with a building using a globally unique identifier, the method comprising:
at a computing platform including at least one processor:
assigning a building identifier to a building, wherein the building identifier is a unique identifier within an identifier space assigned to building identifiers;
receiving information associated with a transaction and the building, the information being identified by the building identifier; and
automatically associating the received information with the building using the building identifier.

2. The method of claim 1 comprising associating a transaction identifier with the transaction, wherein the transaction identifier includes a globally unique identifier being different from the building identifier.

3. The method of claim 2 comprising associating information with the transaction using the transaction identifier.

4. The method of claim 3 wherein the transaction includes a real estate transaction.

5. The method of claim 1 comprising receiving organization information identifying an organization associated with the transaction.

6. The method of claim 4 comprising associating an organization identifier with the organization, wherein the organization identifier includes a globally unique identifier being different from both the building identifier and the transaction identifier.

7. The method of claim 4 comprising associating the organization information with the building using the organization identifier.

8. The method of claim 1 wherein assigning a building identifier to a building includes assigning a building identifier to a house.

9. The method of claim 1 comprising storing the building identifier and one or more of an organization identifier and a transaction identifier in a unified container format.

10. The method of claim 1 wherein assigning a building identifier to a building includes assigning one of an alphanumeric character sequence, a non-alphanumeric character sequence, or a combination thereof to the building.

11. The method of claim 1 wherein the building identifier is expressed as one of a universal product code (UPC)-compliant barcode and a two-dimensional barcode.

12. The method of claim 1 wherein automatically associating the received information with the building using the building identifier includes automatically associating building-specific information at least one of prospectively and retrospectively.

13. The method of claim 1 wherein assigning a building identifier to a building includes assigning a plurality of building identifiers by a central authority.

14. The method of claim 1 comprising associating one or more digital images and corresponding location information with the building identifier.

15. The method of claim 14 wherein the location information is determined using one of triangulation and global positioning system (GPS).

16. The method of claim 14 comprising retrieving the one or more digital images based on the building identifier and the location information.

17. The method of claim 1 comprising providing a web-based interface for presenting the information being identified by the building identifier.

18. A system for managing information associated with a building using a globally unique identifier for the building, the system comprising:
a communications module for receiving information associated with a transaction and the building, the information being identified by a building identifier, wherein the building identifier is a unique identifier within an identifier space assigned to building identifiers; and
a database module for assigning the building identifier to a building and automatically associating the received information with the building using the building identifier.

19. A method for simplifying transactions using a globally unique building identifier, the method comprising:
generating, by a first database, a building identifier that uniquely identifies a building, wherein the building identifier is globally unique across multiple databases;
sharing the building identifier with one or more second databases;
receiving, from at least one of the one or more second databases, a message including the building identifier and information associated with the building; and
associating, at the first database, the building identifier with the information associated with the building.

20. The method of claim 18 comprising persistently storing the information associated with the building in the first database.

21. The method of claim 18 comprising storing, in the first database, the information received from the one or more second databases.

22. The method of claim 18 comprising:
receiving a request, from a user of the first database, requesting information associated with the building; and
retrieving the requested information from the one or more second databases based on the building identifier without storing the information at the first database, wherein the one or more second databases are remotely located from the first database.

23. A computer readable medium comprising computer executable instructions embodied in a tangible computer readable medium and when executed by a processor of a computer performs steps comprising:
at a computing platform including at least one processor:
assigning a building identifier to a building, wherein the building identifier is a unique identifier within an identifier space assigned to building identifiers;
receiving information associated with a transaction and the building, the information being identified by the building identifier; and
automatically associating the received information with the building using the building identifier.
